(19) United States
(12) Patent Application Publication
(10) Pub. No.: US 2005/0195873 A1
(43) Pub. Date: Sep. 8, 2005

(54) Organic polariton laser

(76) Inventors: Stephen R. Forrest, Princeton, NJ (US); Russell Holmes, Princeton, NJ (US)

Correspondence Address: KENYON & KENYON, ONE BROADWAY, NEW YORK, NY, 10004, US

(21) Appl. No.: 10/793,968

(22) Filed: Mar. 5, 2004

(51) Int. Cl. H01S 3/14

(52) U.S. Cl. 372/39; 372/70

(57) ABSTRACT

The present invention relates to organic lasers. More specifically, the present invention is directed to an organic laser that provides a self-stimulated source of coherent radiation originating from organic microcavity polaritons. The organic polariton laser of the present invention comprises a substrate, a resonant microcavity comprising an organic polariton emission layer; and an optical pump. In preferred embodiments the optical pump is a microcavity OLED allowing for the fabrication of a self-contained or integrated device.

### FIELD OF THE INVENTION

The present invention relates to organic lasers. More specifically, the present invention is directed to an organic laser that provides a self-stimulated source of coherent radiation originating from organic microcavity polaritons.

### BACKGROUND

The past fifteen years have seen an explosive growth of research interest in the study and application of organic materials as the active media in organic opto-electronic devices. Today, this work has culminated with organic light emitting devices (OLEDs), and specifically phosphorescent OLEDs. Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate.

Lasing action has been demonstrated in an organic laser having optically-pumped slab waveguide structures of vacuum-deposited thin films of small molecular weight organic semiconductors. V. G. Kozlov et al., Conf. on Lasers and Electro-optics CLEO '97, CPD-18, Opt. Soc. Am., Baltimore, Md., May 1997. Lasing from molecular organic as well as polymeric thin films has been shown to span the visible spectrum, extending into the near IR simply by making modifications to the lasing medium [V. G. Kozlov, V. Bulovic, P. E. Burrows, V. Khalfin, and S. R. Forrest, “Unique optical properties of organic lasers,” presented at CLEO '98, San Francisco, 1998]. More importantly, the characteristics of organic lasers are remarkably temperature independent [V. G. Kozlov, V. Bulovic, and S. R. Forrest, “Temperature Independent Performance of Organic Semiconductor Lasers,” Appl. Phys. Lett., vol. 71, pp. 2575, 1997]. For example, the temperature dependence of a DCM2 doped Alq₃ optically pumped organic thin film laser is compared to a GaAs-based laser. The threshold for optically pumped lasing, as well as the lasing wavelength of a molecular organic thin film as a function of temperature show minimal temperature dependence, in contrast to a conventional GaAs-based laser. The almost complete lack of change in these parameters (including slope efficiency) is due to the isolated, quantum nature of the excited state in organic thin films. These molecular states are largely isolated from those of the environment, leading to lack of sharing of electrons in broad energy bands as occurs in inorganic semiconductors.

It is becoming increasingly apparent that the conventional techniques applied to achieving electrically induced laser emission in inorganic semiconductors, such as the use of an intensely pumped double heterostructure, may not be suited for the successfully generation of the laser emission in organic semiconductors. In organic materials, losses related to thin film resistance, polaron quenching and absorption, and singlet exciton annihilation may ultimately prohibit an organic thin film from reaching the lasing threshold by conventional approaches. [M. A. Baldo, R. J. Holmes, and S. R. Forrest, “Prospects for electrically pumped organic lasers,” Phys. Rev. B, vol. 66, pp. 035321, 2002; V. G. Kozlov, G. Parthasarathy, P. E. Burrows, V. B. Khalfin, J. Wang, S. Y. Chou, and S. R. Forrest, “Structures for Organic Diode Lasers and Optical Properties of Organic Semiconductors Under Intense Optical and Electrical Excitations,” IEEE J. Quant. Electron., vol. 36, pp. 18, 2000].

Perhaps the most promising and least explored option involves exploiting cavity polariton formation in organic materials embedded in high Q dielectric microcavities for the generation of coherent radiation. The study of microcavity polaritons in conventional inorganic semiconductors has been intensive since their initial discovery in GaAs in 1992 [C. Weisbuch, M. Nishioka, A. Ishikawa, and Y. Arakawa, “Observation of the coupled exciton-photon mode splitting in a semiconductor quantum microcavity,” Physical Review Letters, vol. 69, pp. 3314, 1992]. Recently, microcavity polaritons in organic materials have been described. [N. Takada, T. Kamata, and D. D. C. Bradley, “Polariton emission from polysilane-based organic microcavities,” Applied Physics Letters, vol. 82, pp. 1812, 2003; P. Schouwink, H. V. Berlepsch, L. Dahne, and R. F. Mahrt, “Observation of strong exciton-photon coupling in an organic microcavity,” Chemical Physics Letters, vol. 344, pp. 352, 2001; D. G. Lidzey, D. D. C. Bradley, M. S. Skolnick, T. Virgili, S. Walker, and D. M. Whittaker, “Strong exciton-photon coupling in an organic semiconductor microcavity,” Nature (London), vol. 395, pp. 53, 1998].

### SUMMARY OF THE INVENTION

The present invention provides an organic polariton laser comprising a substrate, a resonant microcavity comprising an organic polariton emission layer; and an optical pump. In preferred embodiments the optical pump is a microcavity OLED allowing for the fabrication of a self-contained or integrated device.

### BRIEF DESCRIPTION OF THE DRAWINGS

FIG. 1 shows a schematic diagram of a resonant organic polariton laser.

FIG. 2 shows the dispersion relation measured for an organic microcavity containing pseudoisocyanine. The “peak energy” refers to the location of the resonances observed in the reflection spectrum of the structure, corresponding to the coupled exciton-photon eigenstates.

FIG. 3 shows the calculated emission pattern of a microcavity OLED.

### DETAILED DESCRIPTION

The present invention is directed to an organic laser that provides a self-stimulated source of coherent radiation originating from organic microcavity polaritons. The organic polariton lasers of the present invention represent a device with the functionality of a conventional laser, but with considerably different underlying physics. The organic polariton laser comprises a substrate, a resonant microcavity comprising an organic polariton emission layer, and an optical pump.

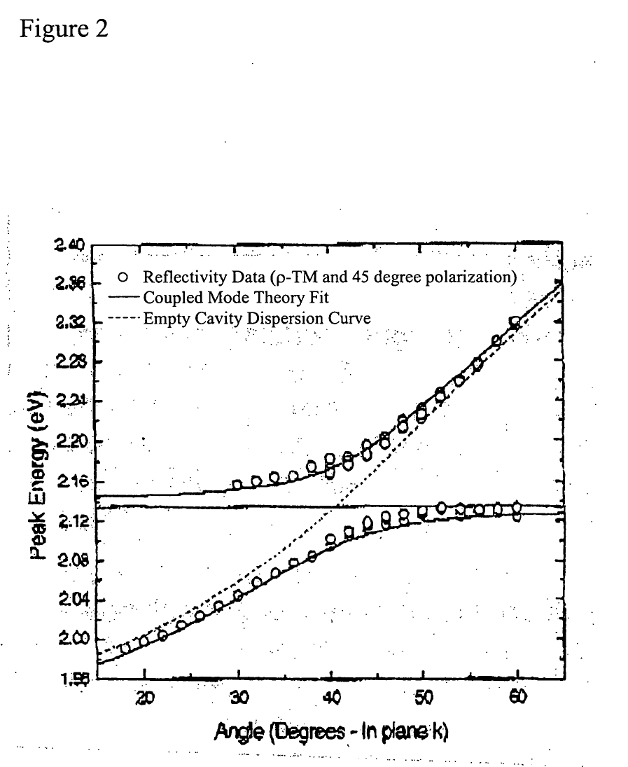

A polariton is a quasi-particle that is an eigenstate of a strongly coupled exciton-photon system. This strong coupling generally occurs with the help of an external microcavity whose resonant frequency is tuned close to the exciton absorption resonance. The active lasing material is generally confined between two mirrors of high reflectivity (for example, distributed Bragg reflectors) and frequently also in at least one quantum well, thus reducing the dimensionality of excitons in the material. In such a system, excitons and photons become strongly coupled as polaritons, with the new dispersion relation of the system being different from both that of the individual exciton and photon, as illustrated by the dispersion of a cavity polariton in a pseudoisocyanine dye (see FIG. 2). Both theory and experiment suggest that the charge neutral polariton should behave as a boson, implying that stimulated scattering (leading to gain) as well the phenomena of macroscopic condensation and coherence should be observable. In fact, a number of experiments using III-V and II-VI semiconductors have reported the observation of stimulated scattering in various forms with some reports, attributing similar observations to the formation of a non-equilibrium Bose-condensation.

Organic microcavities may be exceptionally well suited for the exploitation of the coupled exciton-photon state in a low (or even zero) threshold laser. In inorganic materials, the exciton binding energy is intrinsically so low (˜10 meV) that excitons, and hence polaritons, only exist at low temperature. There are exceptions to this rule with materials such as GaN, ZnO and ITO, where the exciton binding energy is large enough that the polariton state should be observable at room and even at elevated temperatures. [G. Malpuech, A. Di Carlo, A. Kavokin, J. J. Baumberg, M. Zamfirescu, and P. Lugli, “Room-temperature polariton lasers based on GaN microcavities,” Applied Physics Letters, vol. 81, pp. 412, 2002]. However, polaritons in organic microcavities may still hold greater promise due to their large binding energy (˜1 eV).

To date, the most promising work involving polaritons has been the demonstration of bosonic stimulated scattering and optical gain under resonant optical excitation [P. G. Savvidis, J. J. Baumberg, R. M. Stevenson, M. S. Skolnick, D. M. Whittaker, and J. S. Roberts, “Angle-Resonant Stimulated Polariton Amplifier,” Physical Review Letters, vol. 84, pp. 1547, 2000]. Stimulated scattering refers to the tendency of bosons to populate final states whose population is greater than unity. This final state stimulation forms the basis for conventional laser operation, where photon emission is stimulated by the large scale occupation of photon modes in the cavity. Resonant excitation refers to the situation where polaritons are generated with an energy and in-plane wavevector matched to those at the inflection point of the lower branch of the polariton dispersion relation. For a stimulated scattering event to occur, momentum must be conserved. Thus, if polaritons of momentum kₚ scatter with one polariton ending up in the k=0 state, the others must end up in the k=2 kₚ state to conserve momentum. This momentum conservation is observed by detecting photoluminescence from both the k=0 state and the k=2 kₚ state.

Resonant excitation may be used to demonstrate stimulated scattering and gain using polaritons. The same result may be achieved using non-resonant excitation. Non-resonant excitation refers to the case where polaritons have arbitrary energy and in-plane wavevector, similar to what would be expected under electrical excitation. If the case of non-resonant excitation is considered, assume excitons are generated at high k, and permitted to reduce their energy and in-plane wavevector through the emission of longitudinal optical phonons. This initial phonon emission occurs rapidly in conventional semiconductors (<1 ps) [M. S. Skolnick, A. I. Tartakovskii, R. Butte, D. M. Whittaker, and R. M. Stevenson, “High-Occupancy Effects and Stimulation Phenomena in Semiconductor Microcavities,” IEEE Journal of Selected Topics in Quantum Electronics, vol. 8, pp. 1060, 2002], and is followed by a slower acoustic phonon emission process until excitons fall into the region of the dispersion curve referred to as the “exciton reservoir”, occurring on the high k side of the region of strongest coupling (and hence highest polariton-like character). The challenge to generating gain non-resonantly arises at this point. Below the exciton reservoir, there exists a “bottleneck” toward population of the low k states that results from the competition between phonon-assisted polariton relaxation from the exciton reservoir (˜1 ns) and the increasing escape rate for polaritons from the microcavity as the dispersion curve becomes increasingly photon-like.

The relaxation bottleneck effects the ability to populate states of low k. When the excitation is increased, the bottleneck is suppressed, and the peak photoluminescence intensity peaks at low k. Further increases in excitation should provide for increased suppression of the bottleneck due to increased polariton-polariton and polariton-exciton scattering.

Optical gain and the possibility for self-stimulated coherent emission become possible when the polariton bottleneck is suppressed. In the case of resonant excitation, the bottleneck is automatically eliminated since polaritons are created with an in-plane wavevector that is less than that included in the exciton reservoir, meaning that the polaritons have already effectively bypassed the bottleneck. With the bottleneck no longer a concern, scattering can allow for a significant population to build up at k=0. More difficult to achieve is the self-stimulated case reported under both pulsed [J. Erland, V. Mizeikis, W. Langbein, J. R. Jensen, and J. M. Hvarn, “Stimulated secondary emission from semiconductor microcavities,” Physical Review Letters, vol. 86, pp. 5791, 2001] and continuous wave excitation, where a sufficiently large population builds up a k=0 such that the emission from polaritons stimulates the remaining polaritons in the k=0 state to radiate. Such a situation is analogous to a self-stimulated polariton laser. No threshold needs to be established in this polariton laser, and the polaritonic system is in a regime of strong exciton-photon coupling, while a conventional laser operates in the weak coupling regime. The similarity with the conventional laser comes primarily from the coherent light output.

Resonant excitation has allowed for the generation of gains up to 5000 in semiconductor microcavities [M. Saba, C. Ciuti, J. Bloch, V. Thierry-Mieg, R. Andre, L. S. Dang, S. Kundernann, A. Mura, G. Bongiovanni, J. L. Staehli, and B. Deveaud, “High-temperature ultrafast polariton amplifier,” Nature (London), vol. 414, pp. 731, 2001]. However, for these phenomena to be applicable to lasing, gain under non-resonant excitation needs to be demonstrated. As has already been described, the challenge to achieving gain; or self-stimulated coherent emission is the overcoming of the polariton bottleneck. Skolnick et al. [M. S. Skolnick, A. I. Tartakovskii, R. Butte, D. M. Whittaker, and R. M. Stevenson, “High-Occupancy Effects and Stimulation Phenomena in Semiconductor Microcavities,” IEEE Journal of Selected Topics in Quantum Electronics, vol. 8, pp. 1060, 2002] addressed this, noting that as the pump intensity is increased, the effect of the bottleneck is lessened as a result of increased polariton-polariton and polariton-exciton scattering, allowing for the de-excitation of the polariton to lower k states, and ultimately to the k=0 state. The limitations to this approach is that as the pump intensity is increased in a conventional semiconductor, excitons dissociate into electron-hole pairs (destroying the strong coupling) and also tend to screen each other at large densities, again dissociating the excitons into electron-hole pairs, resulting in the loss of strong coupling.

Organic materials are an excellent candidate to use in suppressing the relaxation bottleneck. Since organic materials can be chosen to consist of tightly bound Frenkel excitons, with binding energies on the order of 1 eV, they should allow strong coupling to persist up to the high pump powers necessary to increase polariton scattering. Additionally, as a result of the large Rabi splittings (i.e. branch splittings) observed for organic microcavity polaritons (˜100 meV compared to <10 meV for inorganic semiconductors), and the large exciton binding energies associated with Frenkel excitons, the strong coupling should be very robust, even at room temperature, in stark contrast with the inorganic semiconductors.

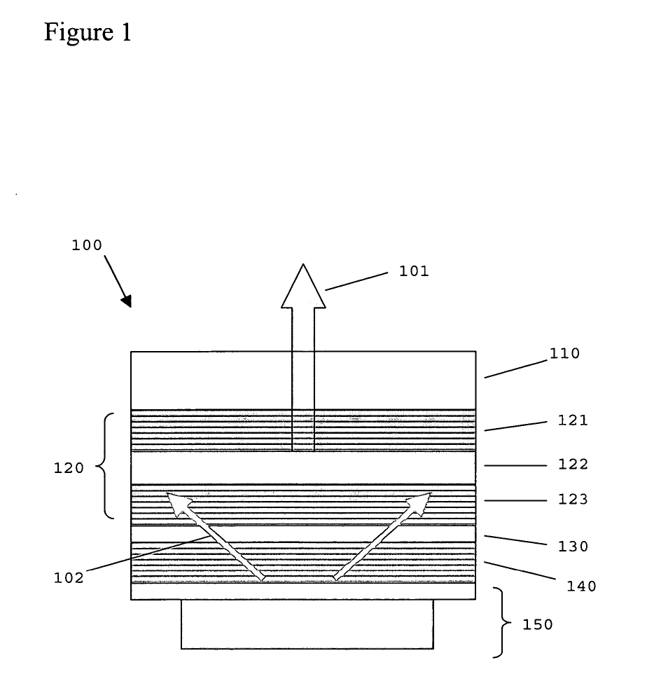

FIG. 1 shows an organic polariton laser 100. The figures are not necessarily drawn to scale. Device 100 may include a substrate 110, a resonant microcavity 120 comprising an organic polariton emission layer 122, and an optical pump 150. The microcavity may be comprised of a first reflective layer and a second reflective layer 121 and 123, adjacent to the organic polariton emission layer 122. The organic polariton laser may further comprise a dielectric spacer 130. In preferred embodiments the optical pump 150 comprises a microcavity OLED. The use of an OLED for the optical pump allows for the construction of a “self-contained” or integrated device. Device 100 may be fabricated by depositing the layers in order.

The Substrate 110 may be made of any transmissive material that provides the desired structural properties. “Transmissive” as used herein indicates that light of the wavelengths emitted by the structure is transmitted through the substrate material without substantial loss of amplitude, and preferably with substantially no loss of amplitude. Glass, plastic and quartz are examples of preferred substrate materials. The material and thickness of substrate 110 may be chosen to obtain desired structural and optical properties.

The microcavity 120 comprises an organic polariton emission layer within a resonant microcavity structure. The microcavity is designed to enhance light-matter interactions. The organic polariton emission layer is generally confined between two mirrors of high reflectivity (for example, distributed Bragg reflectors) and frequently also in at least one quantum well, thus reducing the dimensionality of excitons in the material. In such a system, excitons and photons become strongly coupled as polaritons. In one embodiment the microcavity comprises a first reflective layer and a second reflective layer, 121 and 123. The reflective layers should have a high reflectivity. The resulting cavities should have a high Q, preferably greater than about 500. In a preferred embodiment the reflective layers are comprised of distributed Bragg reflectors (DBRs).

Distributed Braggs reflectors are periodical structures made up of two semiconductor or dielectric materials having different refractive indices. Preferred materials for DBR layers include TiO₂/SiO₂ multilayer stacks, although other DBR materials may be used. The gratings may be fabricated by sputter deposition or plasma deposition, and monitored in situ using ellipsometry as they are deposited. Additionally, the dielectric materials may be deposited by thermal evaporation. The reflective layers may be designed with the typical DBR requirement in mind, namely that the thickness of each dielectric layer be equal to the wavelength of light to be reflected divided by 4 times the index of refraction of the dielectric material at said wavelength (wavelength/(4×n)).

The effective length of the microcavity should be equal to an integer number of half wavelengths (m×wavelength/2) of the light to be confined (where m is an integer and the wavelength is that of the light in the material). Additionally, the photon should experience no net phase shift upon a round trip through the cavity at resonance.

The organic polariton layer 122 comprises an organic material. These compounds are characterized by a very small Franck-Condon shift—i.e. the emission and absorption spectra strongly overlap, creating coupling between the photon (in the absorption spectrum) and the exciton (whose characteristic emission overlaps absorption). The organic polariton emission medium may be comprised of, for example, compounds that form J aggregates, such as cyanine dyes. Examples of suitable materials include a psuedoisocyanine and 1,1′-dialkyl-2,2′-cyanines. Other materials include transition metal porpyhrins (e.g. phenyl-porphyrin zinc) and a-conjugated polysilanes (e.g. poly(n-butylphenylsilane)). However, other materials that demonstrate strong coupling may be used.

Device 100 may include a dielectric spacer 130. The dielectric spacer layer may be included as a means to reduce damage to the polariton DBR stack from the deposition of the OLED DBR stack. Additionally, the dielectric spacer may function as a means of tuning the outcoupling properties of the OLED into the polariton stack. The only requirement for the dielectric spacer layer is that it must be transparent to the light emitted from the OLED. Materials which may be appropriate for use in the dielectric spacer includes silicon oxide, silicon nitride, lithium fluoride, tellurium oxide, titanium oxide, etc.

Any light emitting device may be used as the pump source, so long as the emitted light is of sufficient intensity and the wavelength is appropriate to match the resonance of the polaritons generated in the organic polariton emission layer. In a preferred embodiment, an OLED is employed as the optical pump 150. An OLED pump is preferred as they can be fabricated on top of other devices at room temperature. The OLED pump is generally inexpensive to fabricate and allows for the construction of an integrated device.

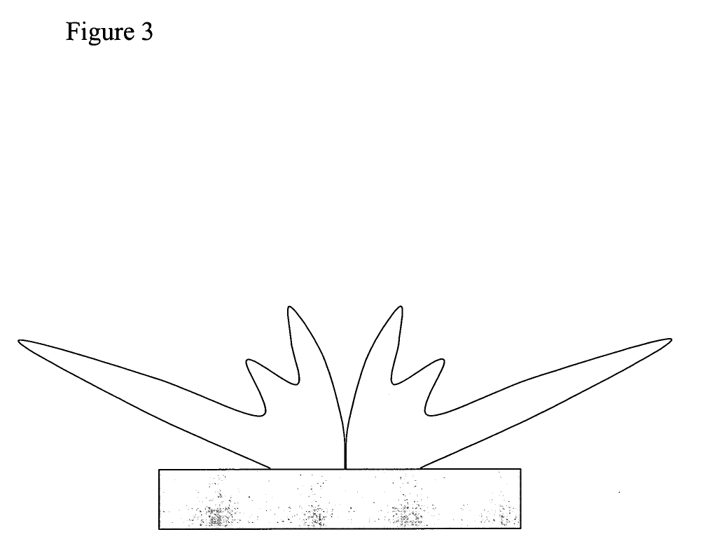

In a preferred embodiment, the pump source comprises a microcavity emitting OLED. The microcavity emitting OLED comprises an OLED structure 150 and a DBR 140. The OLED DBR is detuned from the DBRs of the microcavity 120. The output of the microcavity emitting OLED, represented by the arrows 102, is focused at the correct angle (resonance angle) to match the resonance of the polariton microcavity. The OLED DBR is tuned so that the maximum emission emerges at a k-value equal to that needed to pump the polariton medium at the inflection point of its dispersion curve. A calculated angular emission pattern from such a microcavity OLED is shown in FIG. 3. The microcavity OLED can focus a significant amount of light intensity into the desired angle. The OLED cavity (DBR) should be tuned to generate the maximum number of polaritons in the upper cavity 120 such that gain and transparency can be achieved.

The selection of a particular OLED structure or emissive material depends on the material selected to exhibit strong coupling. Thus, the only general requirement for the OLED is that it be of the highest possible quantum efficiency and that its output spectrum overlap with the absorption spectrum of the active material of the organic polariton emission medium for resonant or non-resonant excitation (depending on which scheme is desired). Materials and methods for the fabrication of the OLED are known in the art, such as those disclosed in U.S. Pat. Nos. 6,645,645, 6,639,357, 6,303,238 and 6,310,360; and U.S. Patent Application Publication Nos. 2002-0034656; 2002-0182441; and 2003-0072964; and WO-02/074015, each of which is incorporated herein by reference in their entirety.

Techniques for depositing the materials used in the embodiments of the present invention are well known in the art. For example, a preferred method of depositing organic layers is by thermal evaporation; a preferred method of depositing metal layers is by thermal or electron-beam evaporation; a preferred method of depositing ITO is by electron-beam evaporation or sputtering. However, the present invention contemplates the use of any suitable method of depositing layers of material.

In one embodiment of the invention, the first polariton cavity DBR is grown onto a glass substrate. The gratings may be fabricated by sputter deposition or plasma deposition, and monitored in situ using ellipsometry as they are deposited. Next, the organic polariton emission medium, for example a psuedoisocyanine which forms J aggregates, is deposited. Then a second DBR stack is deposited finishing the high Q cavity. Next, a dielectric spacer is grown. The device is completed by fabricating a microcavity emitting OLED onto the polariton cavity surface. This begins by depositing a third DBR detuned from the DBRs of the polariton structure. Then an ITO anode is sputtered onto the OLED DBR, followed by a high intensity OLED layer structure, finishing up with a metal cathode.

In another embodiment, a non-resonant polariton laser may be fabricated, which differs from the resonant device in that the OLED DBR can be omitted. Without resonance, there is no strong angular dependence of the pump light; hence the simple Lambertian pattern of a standard OLED.

Devices fabricated in accordance with embodiments of the invention may be incorporated into a wide variety of consumer products, including communications devices, printers, etching systems, measuring devices, optical memory devices, display devices, and sensor devices. The devices of the invention may also be employed as wavelength references for wavelength division multiplexing, optical heterodyning and optical clock applications. Many of the devices are intended for use in a temperature range comfortable to humans, such as 18 degrees C. to 30 degrees C., and more preferably at room temperature (20-25 degrees C.).

It is understood that the various embodiments described herein are by way of example only, and are not intended to limit the scope of the invention. For example, many of the materials and structures described herein may be substituted with other materials and structures without deviating from the spirit of the invention. It is understood that various theories as to why the invention works are not intended to be limiting. For example, theories relating to charge transfer are not intended to be limiting.

While the present invention is described with respect to preferred embodiments, it is understood that the present invention is not limited to these embodiments. The present invention as claimed therefore includes variations from the preferred embodiments described herein, as will be apparent to one of skill in the art.

1. An organic polariton laser comprising:
a substrate;
a resonant microcavity comprising an organic polariton emission layer; and
an optical pump.

2. The organic polariton laser of claim 1, wherein the microcavity has a Q greater than about 500.

3. The organic polariton laser of claim 1, wherein the microcavity comprises a first reflective layer, an organic polariton emission layer, and a second reflective layer.

4. The organic polariton laser of claim 2, wherein the first reflective layer and the second reflective layer are DBR layers.

5. The organic polariton laser of claim 3, wherein the DBR layers each comprise TiO₂/SiO₂ multilayer stacks.

6. The organic polariton laser of claim 1, wherein the optical pump comprises a microcavity OLED.

7. The organic polariton laser of claim 1, wherein the organic polariton emission layer comprises a pseudoisocyanine.
